(19) United States
(12) Patent Application Publication
(10) Pub. No.: US 2004/0182238 A1
(43) Pub. Date: Sep. 23, 2004

(54) Sealing structure and master cylinder and brake booster combination incorporating the same

(75) Inventor: Katsuhiro Mita, Gamagouri-shi (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/765,890

(22) Filed: Jan. 29, 2004

(30) Foreign Application Priority Data
Feb. 3, 2003 (JP) 2003-25989

(51) Int. Cl. F16J 9/00

(52) U.S. Cl. 92/245

(57) ABSTRACT

A sealing structure is provided with a seal member for sealing a double fitting portion where an annular member is fit in the internal surface of an outer member at its outer circumferential surface and is also fit on the outer circumferential surface of an inner member at its internal surface. In the sealing structure, the seal member is attached to an end surface of the annular member with an annular groove on its back surface being fit on an annular projection axially protruding from an end surface of the annular member at a radially mid position. At its forward end surface, the seal member is provided with annular outer and inner lips which are axially protruded for respective contacts with the internal surface of the outer member and the outer circumferential surface of the inner member, and is further provided an annular separation zone between the annular outer and inner lips. In a preferred application, the sealing structure is incorporated in a combination of a master cylinder device and a brake booster device having a pull type input rod, wherein first and second master pistons are slidably inserted in a master cylinder of a cylinder body with a piston rod passing through the second master piston to be connected to the first master piston. In this case, the outer member, the annular member and the inner member in the sealing structure are replaced respectively by the cylinder body, the second master piston and the piston rod in the combination, and the seal member of the searing structure operates to seal the clearance between the internal surface of the master cylinder and the outer circumferential surface of the second master piston and the clearance between the internal surface of the second master piston and the outer circumferential surface of the piston rod.

### INCORPORATION BY REFERENCE

This application is based on and claims priority under 35 U.S.C. sctn. 119 with respect to Japanese Application No. 2003-25989 filed on Feb. 3, 2003, the entire content of which is incorporated herein by reference.

### BACKGROUND OF THE INVENTION

1. Field of the Invention

The present invention relates to a sealing structure for sealing a double fitting portion where an annular member is fit in the internal surface of an outer member at its outer circumferential surface and at the same time, is fit on the outer circumferential surface of an inner member at its internal surface. It also relates to a combination of a master cylinder device and a brake booster device with a pull type input rod which combination incorporates the sealing structure therein.

2. Discussion of the Related Art

As described in Japanese unexamined, published patent application No, 2001-294138, there has been known a combination of a master cylinder device and a brake booster device having a pull type input rod. In the known combination, a first master piston is inserted into a master cylinder of a master cylinder device. A second master piston is inserted into a rear end portion spaced from the first master piston of the master cylinder. A piston rod bodily formed on the first master piston passes through the second master piston and is protruded from the rear end wall of the master cylinder to be operated by the brake booster device. In the known combination, the second master piston is to be fluid-tightly fit in the master cylinder at its outer circumferential surface and at the same time, to be fluid-tightly fit on the outer circumferential surface of the piston rod at its internal surface.

There has been also known another combination of a master cylinder device and a brake booster device having a pull type input rod as described in U.S. Pat. No. 4,505,114 to L. H. Haar. In this combination, the brake booster device is mounted on the forward end of the master cylinder device. The interior of a brake booster is divided by a,,diaphragm into a constant pressure-chamber and a variable pressure chamber. The input rod which operates a valve mechanism to make the variable pressure chamber communicate selectively with the atmosphere and the constant pressure chamber extends to pass through a master piston and a master cylinder and is connected to a brake pedal. The master cylinder device incorporates therein a sealing structure for fluid-tightly sealing a double fitting portion where the master piston is fit in the master cylinder at its outer circumferential surface and is also fit on the outer circumferential surface of the input rod at its internal surface. In the searing structure, a seal member is kept in abutting contact with an end surface of the master piston at the back surface of its base portion. The seal member axially protrudes an outer lip from an outer circumferential edge of the base portion for fitting engagement with the internal surface of the master cylinder and also axially protrudes an inner lip from an inner circumferential edge of the base portion for fitting engagement with the outer circumferential surface of the input rod. The United States patent to Haar further discloses another sealing structure, wherein separate seal members are secured on a master piston respectively for sealing the clearance between the outer circumferential surface of the master piston and the internal surface of a master cylinder and for sealing the clearance between the internal surface of the master piston and the outer circumferential surface of an input rod.

However, in the first mentioned sealing structure employing the seal member which axially protrude the outer and inner lips respectively from the outer and inner circumferential edges of the base portion, the seal member is displaced when a force is exerted on one of the outer and inner lips, and the displacement of the seal member brings adverse influence on the other lip. In this way, the sealing operations of the both lips interfere with each other, whereby the sealing performance of the seal member is degraded. On the other hand, where the separate seal members are used for the double fitting portion, there is involved a shortcoming that the master piston is unavoidable to be enlarged in diameter or length.

### SUMMARY OF THE INVENTION

Accordingly, it is a primary object of the present invention to provide an improved sealing structure for a double fitting portion which is capable of being miniaturized or downsized without sacrifice of the sealing performance.

Another object of the present invention is to provide a combination of a master cylinder and a brake booster device incorporating therein an improved sealing structure of the type as set forth above.

Briefly, according to the present invention, there is provided a sealing structure with a seal member for sealing a double fitting portion where an annular member is fit in an internal surface of an outer member at its outer circumferential surface and is also fit on the outer circumferential surface of an inner member at its internal surface, The sealing structure comprises an annular projection axially protruding from an end surface of said annular member at a radial mid position between the outer circumferential surface and the internal surface of said annular member. An annular groove is formed on the back surface of a base portion of the seal member, and the said seal member is held in contact at the back surface of the base portion with the end surface of the annular member, with the annular groove being fit on the annular projection of the annular member. Further, an annular outer lip axially protrudes from the outer circumferential edge portion of the base portion for contact with the internal surface of the outer member, and an annular inner lip axially protrudes form the inner circumferential edge portion of the base portion for contact with the outer circumferential surface of the inner member. An annular separation zone is further formed on the forward end surface of the base portion between the outer and inner lips.

With this configuration, when pressurized fluid is applied toward the end surface of the annular member, the base portion of the seal member is pressured on the end surface of the annular member, and the outer and inner lips receiving the pressure are pressured respectively on the internal surface of the outer member and the outer circumferential surface of the inner member thereby to seal the clearance between the internal surface of the outer member and the outer circumferential surface of the annular member and the clearance between the internal surface of the annular member and the outer circumferential surface of the inner member. At this time, since the pressurized fluid acts on outer and inner surfaces of the annular, separation zone, the outer and inner surfaces of the annular groove formed on the back surface of the base portion are pressured respectively on the outer and inner surfaces of the annular projection protruding from the end surface of the annular member. Thus, the seal member works as if there are provided two seal members each with a cup shape in cross-section which respectively seal the clearance between the internal surface of the outer member and the outer circumferential surface of the annular member and the clearance between the internal surface of the annular member and the outer circumferential surface of the inner member. This advantageously prevents the force acting on one of the outer and inner lips from displacing the seal member in the radial direction. As a consequence, adverse influence on the other lip can be obviated, so that the performance of the seal member is not degraded. Further, since the double fitting portion can be sealed by one seal member, the sealing structure for the double fitting portion can be miniaturized or downsized.

In another aspect of the present invention, there is provided a combination of a master cylinder device and a brake booster device having a pull type input rod, and the sealing structure of the character set forth above is incorporated in the master cylinder device. That is, in the combination, the interior of a brake booster is partitioned by a diaphragm into a constant pressure chamber and a variable pressure chamber, and a valve mechanism is provided in a piston secured to said diaphragm and is operable by the input rod for making the variable pressure chamber communicate selectively with the atmosphere and the constant pressure chamber thereby to move the diaphragm back and forth. Also in the combination, a master piston is slidably inserted in a master cylinder formed in a cylinder body, and a piston rod passing through the master piston is axially moved rearward with the rearward movement of the diaphragm to generate a pressurized brake pressure. Further, the combination includes the sealing structure of the character set forth above for sealing the clearance between the internal surface of the master cylinder and the outer circumferential surface of the master piston and the clearance between the internal surface of the master piston and the outer circumferential surface of the piston rod. In this case, the cylinder body, the master piston and the piston rod operate respectively as the outer member, the annular member and the inner member defined in the sealing structure.

With this configuration, when the valve mechanism is operated by the input rod, the atmosphere is led into the variable pressure chamber to retract the diaphragm, and with the retraction of the diaphragm, the piston rod is moved axially rearward to generate pressurized brake fluid. As the pressurized fluid acts on the forward end, surface of the master piston fit on the piston rod, the base portion of the seal member is pressured on the forward end surface of the master piston, and the outer and inner lips receiving the pressure are pressured respectively onto the internal surface of the master cylinder and the outer circumferential surface of the piston rod. Therefore, the sealing structure for sealing the clearance between the internal surface of the master cylinder and the outer circumferential surface of the master piston and the clearance between the internal surface of the master piston and the outer circumferential surface of the piston rod can be miniaturized or downsized without degrading the sealing performance thereof. Thus, the combination of the master cylinder device and the brake booster device having the pull type input rod can be downsized while maintaining the sealing performance high.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a longitudinal sectional view of a combination of a master cylinder device and a brake booster device with a pull type input rod which combination incorporates therein a sealing structure according to the present invention;

FIG. 2 is a fragmentary sectional view showing the sealing structure in an enlarged scale;

FIG. 3 is a front view of a second master piston incorporated in the master cylinder device; and

FIG. 4 is a front view of a second master piston with another sealing structure in a second embodiment according to the present invention.

### DETAILED DESCRIPTION OF THE PREFERRED EMBODIMENTS

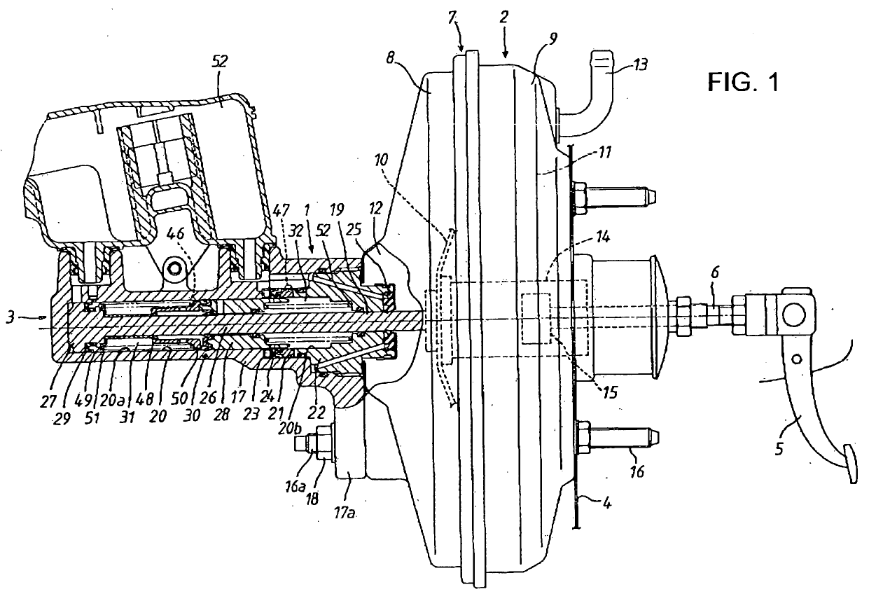

A master cylinder device with a booster device to which a sealing structure according to the present invention is incorporated will be described hereinafter with reference to the accompanying drawings. Referring now to FIG. 1, a numeral 1 generally denotes a combination of a master cylinder device and a brake booster device having a pull type input rod which combination is constituted by combining or connecting a brake booster device 2 with a master cylinder device 3. The combination of the master cylinder device 3 with the brake booster device 2 generally indicated by numeral 1 is fixed to a dashboard (i.e., a partition wall) 4 of a vehicle which separates or compartments a passenger room from an engine room in a motor vehicle. An input rod 6 is pulled rearward by a brake pedal 5 mounted on the dashboard 4 within the passenger room (i.e., on a surface facing the passenger room of the dashboard 4), so that pressurized brake fluid is delivered from the master cylinder device 3 to wheel cylinders (not shown).

The brake booster device 2 has a front shell 8 and a rear shell 9 which constitutes a booster 7 together. The interior of the booster 7 is partitioned with a diaphragm 10 secured between the both shells 8, 9, into a constant pressure chamber 11 and a variable pressure chamber 12. The rear shell 9 is provided with a negative-pressure leading conduit 13 connected therewith, through which the constant pressure chamber 11 is in communication with an intake manifold of an engine (both not shown) thereby to be kept at a negative pressure. A piston 14 is secured to the diaphragm 10 and incorporates therein a valve mechanism 15, which upon being operated by the input rod 6, brings the variable pressure chamber 12 into communication selectively with the atmosphere and the constant pressure chamber 11 thereby to move the diaphragm 10 back and forth. The front shell 8 and the rear shell 9 are connected with each other with two tie rods 16, which are arranged in the circumferential direction of the shells 8, 9. The brake booster device 2 is in abutting engagement at the forward end surface of the front shell 8 with the rear end surface of a flange portion 17a, which is formed on a cylinder body 17 of the master cylinder device 3. The brake booster device 2 is combined or connected with the master cylinder device 3 in such a way that the forward end portion 16a of each tie rod 16 passes through a connection hole formed in the flange portion 17a, with a nut 18 being screwed on a male screw formed on the forward end portion 16a.

A cylinder 20a constituting a master cylinder 20 and a fitting hole 21 are coaxially formed in the cylinder body 17. A small-diameter forward end portion of a cup-shape plug member 22 is fit in the fitting hole 21, with the fitting portion therebetween being sealed, A ring member 23 and a seal member 24 are interposed between the forward end surface of the plug member 22 and a shoulder portion of the fitting hole 21. The plug member 22 is fixedly screwed at its male screw portion into the fitting hole 21 to be secured to the rear end portion of the cylinder body 17. The output rod 19 of the brake booster device 2 passes through a rear end bottom portion of the plug member 22 while being sealed with a seal member 25, and extends forward as a piston rod 26 in the master cylinder 20. A cylinder 20b defining the rear end portion of the master cylinder 20 is formed in the small diameter forward end, portion of the plug member 22.

First and second master pistons 27, 28 are inserted slidably in the master cylinder 20. The first master piston 27 is formed bodily on the forward end of the piston rod 26, and a seal member 29 is fit in an annular groove formed on the first master piston 27 to provide a fluid-tight sealing between the external surface of the first master piston 27 and the master cylinder 20. The second master piston 28 is constituted by a tubular or annular member and is fit with a play on the piston rod 26 passing therethrough. A sealing structure 30 according to the present invention is provided to seal the clearance between the outer circumferential surface of the master piston 28 and the internal surface of the master cylinder 20 and also to seal the clearance between the internal surface of a through hole of the second master piston 28 and the outer circumferential surface of the piston rod 26, so that the master cylinder 20 is divided into first and second cylinder chambers 31, 32.

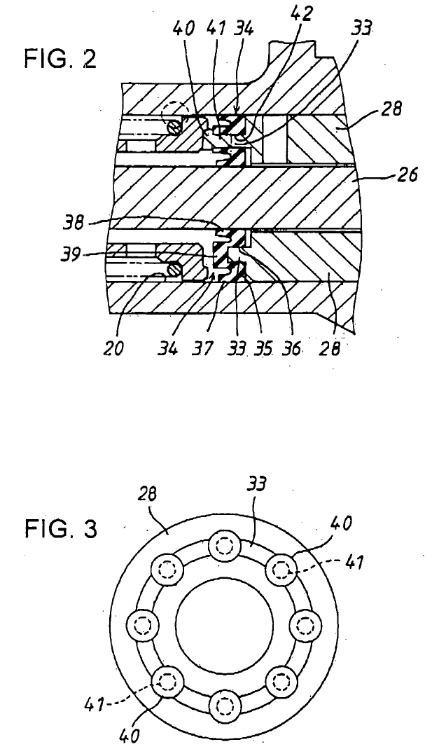

As shown in FIG. 2, an annular projection 33 is protruded from a forward end surface of the second master piston 28 of an annular shape to circumferentially extend at a radially mid portion between the outer and inner circumferential surfaces of the second master piston 28. A numeral 34 denotes a seal member, and a base portion 35 of the seal member 34 is formed at its rear or back surface with an annular groove 36, in which the annular projection 33 is fit, The seal member 34 is in abutting engagement at its back surface with the forward end surface of the second master piston 28 with the annular groove 36 fit on the annular projection 33. At the side of the forward end surface of the base portion 35 of the seal member 34, an annular outer lip 37 and an annular inner lip 38 are axially protruded respectively from the outer and inner circumferential edge portions of the base member 34. The annular outer lip 37 is kept in contact with the internal surface of the master cylinder 20 formed in the cylinder body 37 constituting an outer member, while the annular inner lip 38 is kept in contact with the outer circumferential surface of the piston rod 26 constituting an inner member. Further, an annular separation zone 39 is formed at the forward end surface of the base portion 35 between the outer and inner lips 37, 38 in the radial direction.

As shown in FIGS. 2 and 3, plural engaging poles 41 each round in cross-section and each with a head portion 40 are axially extended from the annular projection 33 protruding from the forward end surface of the second master piston 28. Plural holes 42 for receiving the engaging poles 41 are provided in the separation zone 39 of the seal member 34. The seal member 34 is attached to the forward end surface of the second master piston 28 with the annular groove 36 fit on the annular projection 33 of the second master piston 28 as well as with the engaging holes 42 respectively fit on the engaging poles 41 to be prevented by the head portions 40 from disengaging therefrom. In attaching the seal member 34 to the forward end surface of the second master piston 28, the engaging holes 42 of the seal member 34 are elastically expanded to enable the head portions 40 to pass therethrough.

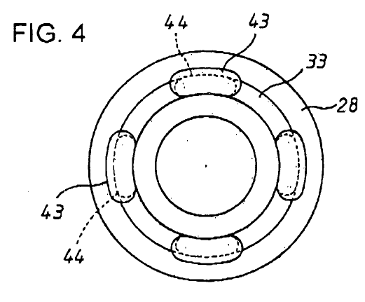

In a modified form or second embodiment, as shown in FIG. 4, plural or four engaging poles 44 each having a head 43 and each taking the form of a curved elongated circle in cross-section are protruded from the annular projection 33 formed on the forward end surface of the second master piston 28 at regular intervals in the circumferential direction. Plural engaging elongated holes into which the engaging poles 44 are respectively inserted are formed in the separation zone 39 of the seal member 34.

The first cylinder chamber 31 is in fluid communication with a first brake system (not shown) through a port 46, while the second cylinder chamber 32 is in fluid communication with a second brake system (not shown) through another port 47 Further, between the first and second master pistons 27, 28, there are interposed a pair of spring seats 49 and 50, which are connected to be accessible to each other with the largest distance therebetween being limited by a telescopic mechanism 48. And, a first compression spring 51 preliminarily compressed is interposed between the pair of spring seats 49 and 50. The preliminary compression force of the first compression spring 51 is set larger than the preliminary compression force of a second compression spring 52 which is interposed between the second master piston 28 and the plug member 22, so that the second master piston 28, when in the inoperative state, is kept stopped at a neutral position where head portions 40 of the engaging poles 41 are in abutting contact on the rear end surface of the spring seat 50. On the top of the cylinder body 17, a reservoir 52 is mounted fixed by means of a pin (not numbered). Only when the first and the second master pistons 27, 28 are at respective inoperative positions, the reservoir 52 is brought into communication with the first and second cylinder chambers 31, 32 to supply brake fluid thereinto.

(Operation)

The operation of the embodiment as constructed above will be described hereinafter. When the brake pedal 5 is stepped on thereby to pull the input rod 6 toward right as viewed in FIG. 1, the valve mechanism 15 is operated to let the atmosphere flow into the variable pressure chamber 12. Thus, the diaphragm 10 and the piston 14 are moved rearward due to the pressure difference between the variable pressure chamber 12 and the constant pressure chamber 11, and the pressurized fluid is supplied from the first cylinder chamber 31 to the first brake system (not shown) through the port 46.

When the pressurized fluid increased in the first cylinder chamber 31 is applied toward the forward end surface of the second master piston 28, the base portion 35 of the seal member 34 is pressured on the forward end surface of the second master piston 28, and the outer and inner lips 37, 38 receiving the pressure are contacted respectively onto the internal surface of the master cylinder 20 and the outer circumferential surface of the piston rod 26 thereby to seal the clearance between the internal surface of the master cylinder 20 and the outer circumferential surface of the second master piston 28 and the clearance between the internal surface of the through hole of the second master piston 28 and the outer circumferential surface of the piston rod 26. At this time, since the pressurized fluid acts on outer and inner surfaces of the annular separation zone 39, the outer and inner surfaces of the annular groove 36 formed on the back surface of the base portion 35 are pressured respectively on the outer and inner surfaces of the annular projection 33 protruding from the forward end surface of the second master piston 28. Thus, the seal member 34 works as if there are provided two seal members of a cup shape in cross-section which respectively seal the clearance between the internal surface of the master cylinder 20 and the outer circumferential surface of the second master piston 28 and the clearance between the internal surface of the second master piston 28 and the outer circumferential surface of the piston rod 26. This advantageously prevents the force acting on one of the outer and inner lips 37 (38) from displacing the seal member 34 in the radial direction. As a consequence, adverse influence on the other lip 38 (37) can be obviated, so that the performance of the seal member 34 is not degraded.

Since the pressure of the brake fluid (i.e., operating fluid) in the first cylinder chamber 31 is increased with the rearward movement of the first master piston 27, the second master piston 28 is also moved rearward as it compresses the second compression spring 52. Thus, the pressurized operating fluid is supplied from the second cylinder chamber 32 to the second brake system (not shown) through the port 47. The second master piston 28 is balanced at a position where it makes the first and second cylinder chambers 31, 32 have the same pressure.

When the brake pedal 5 is released, the valve mechanism 15 is changed over to lead the negative pressure in the constant pressure chamber 11 to the variable pressure chamber 12 to make zero the pressure difference between the variable pressure chamber 12 and the constant pressure chamber 11. Therefore, the diaphragm 10 is moved forward by the resilient force of a return spring (not shown) provided in the brake booster device 2, to be returned to the original position. With the forward movement of the diaphragm 10, the first and second master pistons 27, 28 are advanced by the resilient forces of the first and second compression springs 51, 52 to be returned to their respective original or inoperative positions. Even when the advance movement of the first master piston 27 causes the pressure in the first cylinder chamber 31 to be negative or zero in pressure, it does not occur that the seal member 34 comes off the forward end surface of the second master piston 28 because the plural engaging poles 41 protruding from the forward end surface of the second master piston 28 pass through the engaging holes 42 of the seal member 34 and at the head portions 40 thereof, prevent the seal member 34 from coming off. Further, since the second master piston 28 is urged forward by the second compression spring 52 with the head portions 40 of the engaging poles 41 being in abutting engagement with the rear end surface of the spring seat 50, the seal member 34 can reliably prevented from coming off the forward end surface of the second master piston 28.

Although in the foregoing embodiment, the first master piston 27 is bodily formed on the piston rod 26, they may be provided as separate members in a modified form. That is, a piston rod passes through a through hole formed in a first master piston and is joined to the same by means of an engaging member which is engaged on the forward end of the piston rod in abutting engagement on the forward end surface of the first master piston. And, the sealing structure 30 as described above according to the present invention is incorporated to seal the clearance between the outer circumferential surface of the first master piston and the internal surface of the master cylinder 20 and the internal surface of the first master piston and the outer circumferential surface of the piston rod.

Further, the annular groove 42 of the seal member 34 is fit on the annular projection 33 of the second master piston 28, and the second master piston 28 is urged forward by the second compression spring 52, so that the seal member 34 is put or sandwiched between the rear surface of the spring seat 50 for the first compression spring 51 and the forward end surface of the second master piston 28. Therefore, even in the case that the engaging poles 41 and the engaging holes 42 are not provided respectively on the second piston 28 and the seal member 34, it does not take place that the seal member 34 held on the forward end surface of the second master piston 28 comes off the second master piston 28. In other words, the engaging poles 41 and the engaging holes 42 are not essential in implementing the present invention.

Finally, various features and many of the attendant advantages in the foregoing embodiments will be summarized as follows:

In the embodiment typically shown in FIGS. 2 and 3, the seal member 34 works as if there are provided two independent seal members each with a cup shape in cross-section which respectively seal the clearance between the internal surface of the outer member (i.e., the cylinder body) 17 and the outer circumferential surface of the annular member (i.e., the second master piston) 28 and the clearance between the internal surface of the annular member and the outer circumferential surface of the inner member (i.e., the piston rod) 26. This advantageously prevents the force acting on one of the outer and inner lips 37 (38) from displacing the seal member 34 in the radial direction. As a consequence, adverse influence on the other lip 38 (37) can be obviated, so that the performance of the seal member 34 is not degraded. Further, since the double fitting portion can be sealed by one seal member 34, the sealing structure 30 for the double fitting portion can be miniaturized or downsized.

Also in the embodiment typically shown in FIGS. 2 and 3, the plural engaging poles 41 protruding from the forward end surface of the annular member (i.e., the second master piston) 28 respectively pass through the engaging holes 42 of the seal member 34, and the seal member 34 is prevented by the head portions 40 of the engaging poles 41 from coming off the engaging poles 41. Therefore, even when a negative pressure is applied to the forward end surface of the annular member 28, the seal member 34 can be prevented from being detached from the annular member 28.

Also in the embodiment, the sealing structure 30 shown in FIGS. 2 and 3 is incorporated into the combination 1 of the master cylinder device 3 and the brake booster device 2 having the pull type input rod 6, In this case, when the pressurized fluid acts on the forward end surface of the master piston (i.e., the second master piston) 28 fit on the piston rod 26, the base portion 35 of the seal member 34 is pressured on the forward end surface of the master piston 28, and the outer and inner lips 37, 38 receiving the pressure are pressured respectively onto the internal surface of the master cylinder 20 and the outer circumferential surface of the piston rod 26. Therefore, the sealing structure 30 for sealing the clearance between the internal surface of the master cylinder 20 and the outer circumferential surface of the master piston 28 and the clearance between the internal surface of the master piston 28 and the outer circumferential surface of the piston rod 26 can be miniaturized or downsized without degrading the sealing performance thereof. This advantageously makes it possible to provide the master cylinder device 3 with a brake booster device 2 which can be made small in size and kept high in performance.

Also in the embodiment typically shown in FIGS. 1 and 2, the second master piston 28 is urged forward by the second compression spring 52 to be pressured upon the spring seat 50 on which the first compression spring 51 is seated. Thus, it can be avoided that the seal member 34 held in abutting contact on the forward end surface of the second master piston 28 comes off the second master piston 28.

Obviously, numerous modifications and variations of the present invention are possible in light of the above teachings. It is therefore to be understood that within the scope of the appended claims, the present invention may be practiced otherwise than as specifically described herein.

What is claimed is:

1. A sealing structure with a seal member for sealing a double fitting portion where an annular member is fit in the internal surface of an outer member at its outer circumferential surface and is also fit on the outer circumferential surface of an inner member at its internal surface, said sealing structure comprising:
an annular projection axially protruding from an end surface of said annular member at a radially mid position between said outer circumferential surface and said internal surfaces of said annular member;
an annular groove formed on a back surface of a base portion of said seal member, said seal member being held in contact with said end surface of said annular member at said back surface of said base portion, with said annular groove being fit on said annular projection of said annular member;
an annular outer lip axially protruding from the outer circumferential edge portion of said base portion for contact with said internal surface of said outer member;
an annular inner lip axially protruding form the inner circumferential edge portion of said base portion for contact with said outer circumferential surface of said inner member; and
an annular separation zone formed on said end surface of said base portion between said annular outer and inner lips.

2. The sealing structure as set forth in claim 1, further comprising;
plural engaging poles protruding from said annular projection and each having a head portion; and
plural holes formed in said seal member to pass through said annular separation zone in the axial direction of said seal member for permitting said plural engaging poles to pass therethrough respectively;
wherein said seal member is attached to said end surface of said annular member with said base portion being in abutting contact with said end surface of said annular member, with said annular groove being fit on said annular projection, and with said plural engaging holes being fit respectively on said engaging poles to be prevented by said head portions from coming off said end surface of said annular member.

3. A combination of a master cylinder device and a brake booster device having a pull type input rod wherein the interior of a brake booster is partitioned by a diaphragm into a constant pressure chamber and a variable pressure chamber; wherein a valve mechanism is provided in a piston secured to said diaphragm and is operable by said input rod for making said variable pressure chamber communicate selectively with the atmosphere and said constant pressure chamber thereby to move, said diaphragm back and forth; wherein a master piston is slidably inserted in a master cylinder formed in a cylinder body; and wherein a piston rod passing through said master piston is axially moved rearward with the rearward movement of said diaphragm to generate a pressurized brake pressure;
said combination including the sealing structure as set fort in claim 1 for sealing the clearance between the internal surface of said master cylinder and the outer circumferential surface of said master piston and the clearance between the internal surface of said master piston and the outer circumferential surface of said piston rod, wherein said cylinder body, said master piston and said piston rod operate respectively as said outer member, said annular member and said inner member defined in claim 1.

4. The combination as set forth in claim 3, wherein said sealing structure By further comprises:
plural engaging poles protruding from said annular projection formed on said end surface of said master piston which operates as said annular member, and each having a head portion; and
plural holes formed in said seal member to pass through said annular separation zone in the axial direction of said seal member for permitting said plural engaging poles to pass therethrough respectively;
wherein said seal member is attached to said end surface of said master piston with said base portion being in abutting contact with said end surface of said master piston, with said annular groove being fit on said annular projection formed on said end surface of said master piston, and with said plural engaging holes being fit respectively on said engaging poles to be prevented by said head portions from coming off said end surface of said master piston.

5. A combination of a master cylinder device and a brake booster device having a pull type input rod wherein the interior of a brake booster is partitioned by a diaphragm into a constant pressure chamber and ;a variable pressure chamber; wherein a valve mechanism is provided in a piston secured to said diaphragm and is operable by said input rod for making said variable pressure chamber communicate selectively with the atmosphere and said constant pressure chamber thereby to move said diaphragm back and forth; wherein first and second master pistons are slidably inserted in a master cylinder formed in a cylinder body; and wherein a piston rod passing through said second master piston and connected to said first master piston is axially moved rearward with the rearward movement of said diaphragm to generate a pressurized brake pressure;
said combination including the sealing structure as set fort in claim 1 for sealing the clearance between the internal surface of said master cylinder and the outer circumferential surface of said second master piston and the clearance between the internal surface of said second master piston and the outer circumferential surface of said piston rod, wherein said cylinder body, said second master piston and said piston rod operate respectively as said outer member, said annular member and said inner member defined in claim 1.

6. The combination as set forth in claim 5, wherein said sealing structure further comprises:
plural engaging poles protruding from said annular projection formed on said end surface of said second master piston which operates as said annular member, and each having a head portion; and
plural holes formed in said seal member to pass through said annular separation zone in the axial direction of said seal member for permitting said plural engaging poles to pass therethrough respectively;
wherein said seal member is attached to said end surface of said second master piston with said base portion being in abutting contact with said end surface of said second master piston, with said annular groove being fit on said annular projection formed on said end surface of said second master piston, and with said plural engaging holes being fit respectively on said engaging poles to be prevented by said head portions from coming off said end surface of said second master piston.

7. The combination as set forth in claim 5, wherein:
a first compression spring is further provided to be seated on at least one spring seat between said first and second master pistons; and
a second compression spring is further provided to pressure said second master piston which has said seal member in abutting contact with said end surface thereof, on the rear surface of said at least one spring seat.
